(19) United States
(12) Patent Application Publication
(10) Pub. No.: US 2005/0004780 A1
(43) Pub. Date: Jan. 6, 2005

(54) Virtual assistant for semiconductor tool maintenance

(75) Inventors: Mu-Tsang Lin, Hsin-Chu (TW); Wen-Chang Kuo, Hsin-Chu (TW); Tien-Der Chiang, Hsin-Chu (TW); Chih-Chung Chiang, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., LTD, Hsin-Chu (TW)

(21) Appl. No.: 10/613,139

(22) Filed: Jul. 3, 2003

(51) Int. Cl. G06F 19/00

(52) U.S. Cl. 702/184; 702/185; 700/121

(57) ABSTRACT

The present disclosure provides a smart virtual assistant system to assist in the repair and maintenance of semiconductor tools The virtual assistant system includes an interface for receiving a tool alarm from a specified semiconductor tool and a database including a table for providing information as to what can and cannot be done to the specified semiconductor tool. The virtual assistant system also includes two processing subsystems, one including instructions for deducting tool alarm information from the tool alarm and the other for receiving the tool alarm information, perusing the database, and identifying one or more causes associated with the tool alarm information.

### BACKGROUND

The present invention relates to semiconductor fabrication facilities, and more specifically, to an electronic assistant system for maintaining semiconductor tools.

Since the invention of the integrated circuit (IC), semiconductor industry has been growing dramatically from the primary IC to ultra-large scale IC (ULSI) by technological progress not only in materials, design, and processing, but also in fabrication automation. Advances in IC technology, coupled with a movement towards mass production, provide a driving force for automation. Automation brings higher quality, shorter cycle time and lower cost, which in return drive for broader IC applications and higher market demand.

Integrated circuits are produced by multiple processes in a wafer fabrication facility (fab). These processes include, for example, thermal oxidation, diffusion, ion implantation, RTP (rapid thermal processing), CVD (chemical vapor deposition), PVD (physical vapor deposition), epitaxy, etch, and photolithography. Each process requires very precise control of numerous process parameters. This requirement is typically achieved by a complex system with both hardware and software, collectively referred to as “semiconductor tools.”

For example, a sputtering system has a multi-chamber work station, a vacuum system to provide reduced pressure, a chemical/gas supplier system to provide Argon and Nitrogen, a robotic system to transfer wafers from chamber to chamber, a temperature system to monitor and control chamber/wafer temperature, a high voltage source to produce plasma, and a rotating magnetron to provide uniform and high rate deposition. All of these tools must work correctly, precisely, and synchronously, according to a preset recipe for specific production. If any tool does not function correctly, is out of range, or is out of sequence, the process may fail.

When a tool has a malfunction or problem, equipment engineers are typically required to trouble shoot and fix the problem so that the tool will be available for production as soon as possible. The equipment engineer must have the proper equipment, guide book, and/or standard operating procedure (SOP) to repair the tool, or try to make the repair with available equipment and knowledge. This exacerbates the risk of future malfunction or problem due to an increased likelihood of human error.

Currently, there is no effective methodology to assist engineers in maintaining semiconductor tools when they malfunction, are down, or have any other problems.

### SUMMARY

The present invention provides a smart system to assist in the repair and maintenance of semiconductor tools. In one embodiment, a virtual assistant system is provided for facilitating semiconductor tool maintenance. The virtual assistant system includes an interface for receiving a tool alarm from a specified semiconductor tool and a database including a table for providing information as to what can and cannot be done to the specified semiconductor tool. The virtual assistant system also includes two processing subsystems, one including instructions for deducting tool alarm information from the tool alarm and the other for receiving the tool alarm information, perusing the database, and identifying one or more causes associated with the tool alarm information.

In some embodiments, the database further includes a second table for providing routine maintenance information for the specified semiconductor tool, a third table for providing a predetermined operating procedure for maintaining the specified semiconductor tool, and/or a fourth table for providing a list of high risk actions for the specified semiconductor tool.

In another embodiment, an assistant system is provided for use in maintaining a semiconductor tool. The assistant system includes a first interface for receiving tool alarms from a plurality of different semiconductor tools connected via servos and a database including a plurality of problem trees, a plurality of cause trees, and a plurality of action trees. The assistant system also includes a processing subsystem for analyzing the tool alarms by comparing them to the problem trees and providing a cause and action message based on the analysis.

In another embodiment of the present invention, a method provides information to repair a semiconductor tool. The method includes the steps of receiving a tool alarm when a tool problem occurs and upon receipt of the tool alarm, providing tool alarm information to a database to determine a problem, cause, and action. The method checks if the tool alarm information matches an item in a standard operation procedures (SOP) table of the database. If so, SOP information is provided in a tool alarm message that is sent to a remote terminal for use in repairing the semiconductor tool.

### BRIEF DESCRIPTION OF THE DRAWINGS

FIGS. 1a and 1b are device diagrams of a smart assistant system according to one embodiment of the present invention.

FIG. 2 is an information process flow of the smart assistant system.

FIG. 3 is a Problem-Cause-Action (PCA) flow chart of tool alarms.

FIGS. 4a-4e illustrate interfaces of the smart assistant system of FIG. 1.

### DETAILED DESCRIPTION

The following description provides a new and unique virtual expert system to assist engineers in trouble shooting and maintaining semiconductor tools. The system includes a novel database with a problem-cause-action (PCA) tree structure. The system has self-learning ability to extend its database. The database is shared by all semiconductor tools of the same type in one or more fabs. It is understood, however, that the embodiments below are not necessarily limitations to the present disclosure, but are used to describe a typical implementation of the invention.

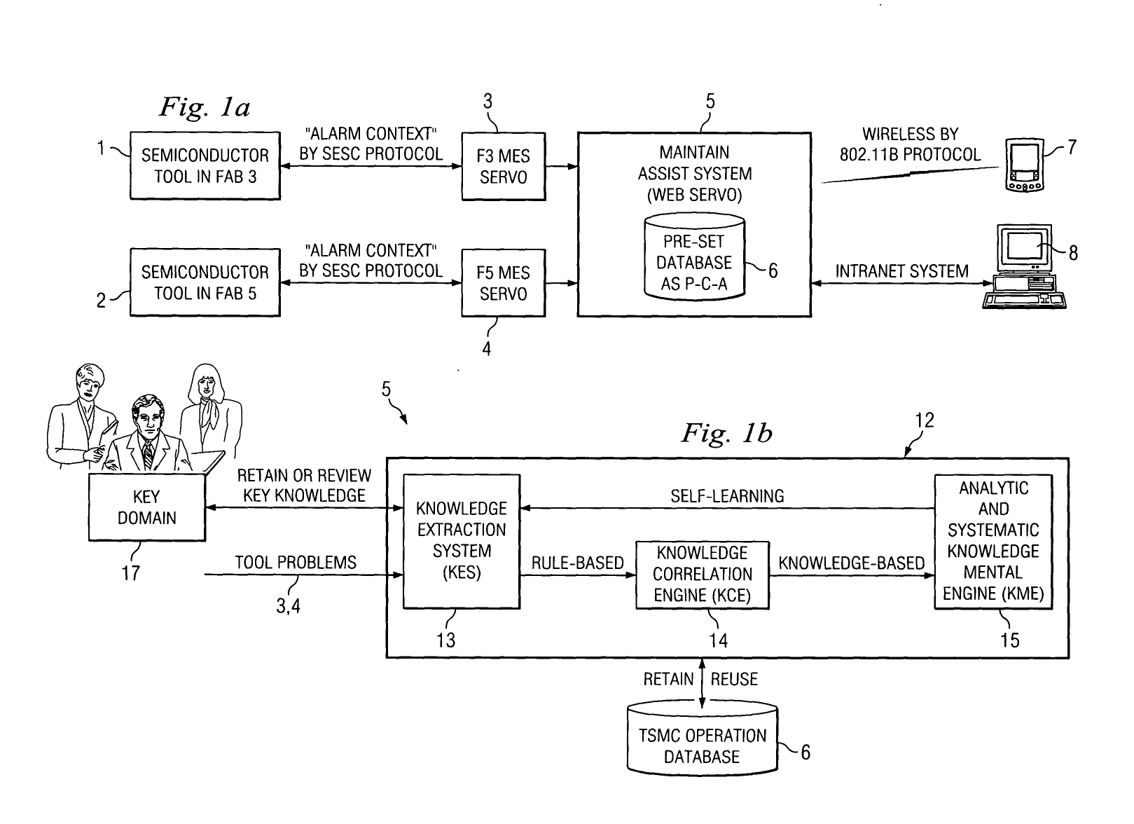

Referring to FIG. 1a, a smart assistant system according to one embodiment of the present invention is designated with the reference numeral 5. All semiconductor tools in different manufacture plants (or fabs) are connected to the assistant system 5 through servos of a manufacture execution system (MES) according to a well known Software Engineering Standards Committee (SESC) protocol. It is understood that the MES and SESC protocol are being discussed merely for the sake of example. For further example, only two semiconductor tools are illustrated: a first tool 1 linked to a servo 3 and a second tool 2 linked to a servo 4. The assistant system 5 has a preset database with a PCA tree structure 6 for each type of tools, which will be described in further detail below. In the present embodiment, all semiconductor tools of the same type share one common PCA database. The assistant system 5 is also linked to one or more terminals 7, 8. For example, an electronic handheld computer device (PDA) 7 is linked to the system 5 through wireless by 802.11B protocol, and a desktop computer 8 is linked to the system through intranet system. Other examples of terminals include wireless telephones such as a cellular telephone, wired telephone which can be utilized, for example, by using an autodialer, and display panels that appear in a maintenance facility.

Semiconductor tools are subject to many tool problems, including mechanical malfunction, out of range parameters, and software failures. If a tool problem occurs, the semiconductor tool 1, 2 will send out a tool alarm to the assistant system 5 through a connected MES servo 3, 4. The assistant system 5 will correlate information from the tool alarm to the PCA database 6, extract the description of the problem, possible causes and optional actions, and inform the related tool overseers (e.g., equipment engineers responsible for the tool, manufacturers of the tool, and/or entities contracted to maintain the tool) of the tool alarm with the above PCA information through the PDA 7 or computer 8. The tool overseers can do failure mode analysis with assistance of the above PCA information, finalize the maintenance action, which could be one set of the actions provided by the assistant system 5, or create a new action. The assistant system 5 will record maintenance actions and trace the tool status before this trouble-shooting case is closed.

If the maintenance actions are newly created, then the actions will be traced, evaluated, confirmed, and a determination will be made as to whether to retain the new action in the database 6. This self-learning ability will facilitate the assistant system's 5 collection of tool maintenance information on a real-time basis. Specifically, the database 6 of the assistant system 5 will automatically acquire and retain new PCA data from fab-wise maintenance. The database 6 is retrievable by engineers for training purposes, inheritable from old model tools to new models, and transferable between different fabs and different sites. In addition, if a finalized action, selected or created by the engineer for maintenance, is rated by the assistant system as a high-risk action, the system 5 can automatically inform all of the related owners about this action and trace all following maintenance procedures to minimize risks.

Referring now to FIG. 1b, the assistant system 5 comprises the database 6 and a shell 12. In the present embodiment, the database 6 stores all maintenance data from initial acquisition and self-learning through the whole lifetime of the system in a PCA tree structure. The shell 12 includes three function blocks, a knowledge extraction system (KES) 13, a knowledge correlation engine (KCE) 14, and knowledge mental engine (KME) 15 as a user interface. The shell 12 also includes an interface for the MES servos 3, 4 and a key domain interface 17 for receiving input from systems and/or experts to initialize the database 6.

The key domain interface 17 can be used to acquire different types of maintenance knowledge, which can later be reviewed, categorized, and incorporated into the database 6 through the KES function block 13. This structuring and knowledge acquisition can be used to initialize the database 6 and make the system 5 ready for use. The database 6 also contains three preset tables, one a “miss” operation (MO) table, one a standard operation procedure (SOP) table, and one a high-risk table. The MO table can be used to inform an entity such as a user what can and cannot be done to a tool (hereinafter “allowances and restrictions information”) and what is required or necessary for maintenance (hereinafter “requirements information”). The SOP table can be used to inform an entity such as the user which operating procedure to follow for an identified maintenance procedure. The high-risk table lists all actions of high risk—either to the tool or to the maintenance engineer. Each action in the database 6 may link to one or all three tables as needed. All three tables are updateable through the lifetime of the system 5.

Another function of the KES block 13 is to receive a tool alarm from the servos 3, 4, and pass tool alarm information to the KCE 14 for correlation. The KCE block 14 can correlate the tool alarm information and help specific cause(s) of the tool alarm to be identified and action(s) to be performed on one or more tools, including any allowances and restrictions information, requirements information, and/or SOP information, if any. This correlation is based on a sequence of IF-THEN rules to search down to identify specific problems, causes, and actions. The result is the necessary problem-cause-action (PCA) information

The KME 15 can send the PCA information and any MO/SOP information to related tool overseers by sending the information to the output devices 7, 8 (FIG. 1a). In this way, the KME 15 functions as an interface for dual-way communication between the system 5 and users. Users can select an action provided by the database 6 or create a new action after inspection and analysis. This decision of maintenance action can be feed back to the assistant system 5. The newly created action will be extracted by the KES 13 and may be used to extend the PCA database 6. The database 6 not only exports data for use but also imports data for extension and growth.

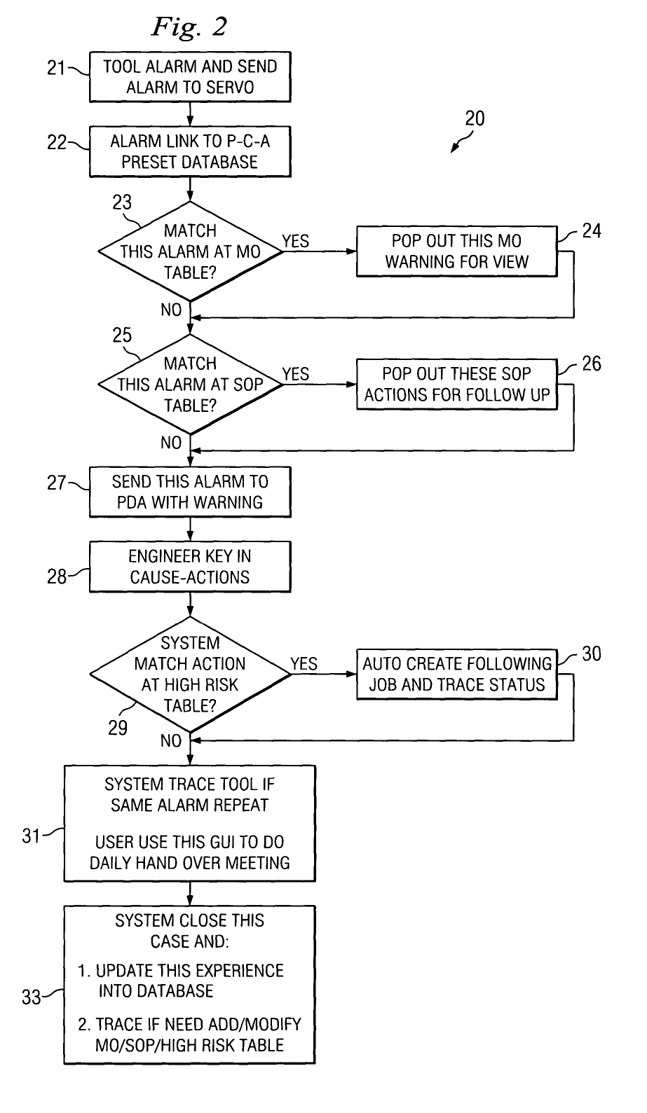

Referring to FIG. 2, an information process 20 is provided for receiving and handling a tool alarm. At step 21, when a tool problem occurs, a tool alarm is sent to a servo 3, 4 (FIG. 1) and further to the assistant system 5. At step 22, upon receiving the tool alarm from a servo, the assistant system 5 will provide tool alarm information to the PCA database 6 to determine a problem, cause, and action. At step 23, the system checks if the tool alarm matches any item in the MO table. If it does, then at step 24 the system 5 will provide allowances and restrictions information and requirements information to a warning message. If the alarm does not match any item in the MO table, or upon completion of step 24, at step 25 the system will perform SOP matching. After completing the MO matching, the system will check if the tool alarm matches any item in the SOP table. If it does, then at step 26 the system 5 will provide SOP warning information to the warning message. If the alarm does not match any item in the SOP table, or upon completion of step 26, at step 27 the system will perform SOP matching.

At step 27, the system 5 sends a tool alarm message including problem-cause-action description, allowances and restrictions information and requirements information, and SOP if any, to the terminals 7, 8 (FIG. 1a). At step 28, the tool engineer will analyze the alarm information, check the tool status, and make decision on final action. The engineer may select one set of cause-actions from the alarm information, or create a new set of cause-actions, and provide it to the system 5. At step 29, the system 5 will review the actions chosen by the users, and check if the actions match any item in the high-risk table. If the actions do match certain high-risk actions, then at step 30 the system will automatically create a follow-up job, trace for status, inform, and update all related owners. If the actions do not match high-risk actions, the system will proceed to step 31 and the system will trace tool status for any occurrence of the same alarm. The users can use all of the above available information in the system to create a report for daily handover meeting. At step 33, the system 5 may retain this experience into the PCA database 6, and also trace if there is any need to add or modify the MO, SOP, and/or high risk tables based on this experience.

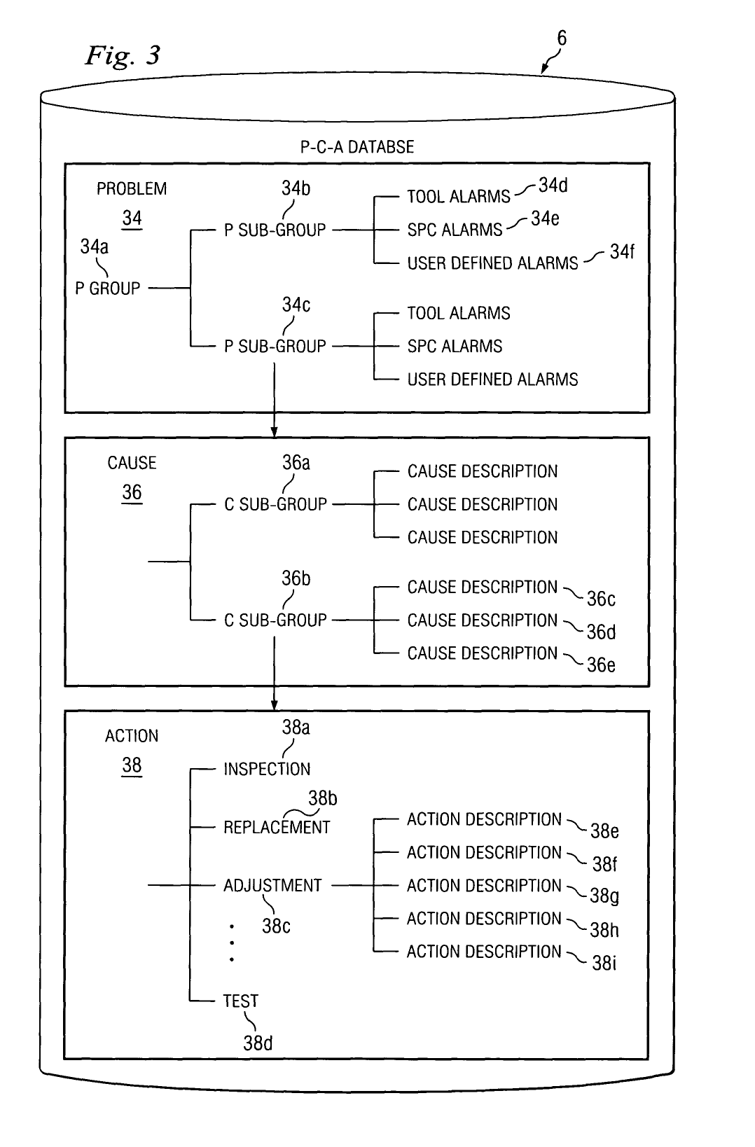

Referring to FIG. 3, the PCA database 6 includes a tree structure of tool problems that is linked to one or more causes. Each cause may be linked to one or more pertinent action(s) to fix the problem accordingly. Based on this PCA database 6, the system 5 can start from a problem, trace down to cause(s) and further to corresponding action(s).

Tool problems 34 are in a tree structure by themselves. Tool problems 34 may be categorized into many P groups. Each P group could be divided into many subgroups. Each P subgroup can be further divided into next level subgroups. Overall, this tree structure could have as many levels as necessary. The lowest P sublevel will be further linked to all related alarms. In the example of FIG. 3, there are three group levels including the tool alarms level for a single P group. P group 34a can represent, for example, a software problem. Other P groups can include alignment problems, overheating problems, and so forth. The P group 34a includes, for the sake of example, two P subgroup 34b and 34c. P subgroup 34b can represent, for example, software problems with an automatic control system of a certain processing device and P subgroup 34c can represent software problems with a user interface of the processing device. In this three-tier example, each of the lowest level P subgroups is specific and linked to specific alarms. To continue the previous example, the P subgroup 34b includes Tool alarms 34d, SPC alarms 34e, and User-defined alarms 34f. SPC stands for statistical process control. User-defined alarms could be any alarm such as an alarm to remind for periodic routing maintenance. In this tree structure, the system defines each generic problem into a very specific problem, which has one or more specific alarms. Further and more significantly, each of the lowest P subgroups will be linked to a cause. For instance, P subgroup 34c is linked to causes 36.

The causes 36 are also in a tree structure by themselves, similar to the problem tree structure. The causes may be categorized into many C groups and subgroups. Each C subgroup can be further divided into next level subgroups and so forth. Overall, this tree structure could have as many levels as necessary. C subgroups 36a and 36b are schematically shown as exemplary elements in a cause tree. Each of the lowest C subgroups would be more specific and linked to a set of cause descriptions. For example, C subgroup 36b may be overheating, which is further linked to a set of cause descriptions 36c, 36d, and 36e. Examples of cause descriptions include blocked air vent, obstruction, and electrical short. Further, each lowest level C subgroup will be linked to an action. For instance, C subgroup 36b is linked to actions 38.

The actions 38 are also in a tree structure by themselves, similar to the problem tree and the cause tree structures. The actions may be categorized into many A groups and subgroups. Each A subgroup can be further divided into next level subgroups. Overall, this tree structure could have as many levels as necessary. Examples of A subgroups include inspection 38a, replacement 38b, adjustment 38c, and test 38d. Each of the lowest A subgroups would be more specific and is linked to a set of action descriptions. For example, A subgroup 38c is linked to a set of action descriptions adjust valve 38e, adjust stage motor 38f, adjust stage height 38g, adjust stage pitch 38h, and adjust stage rotation 38i.

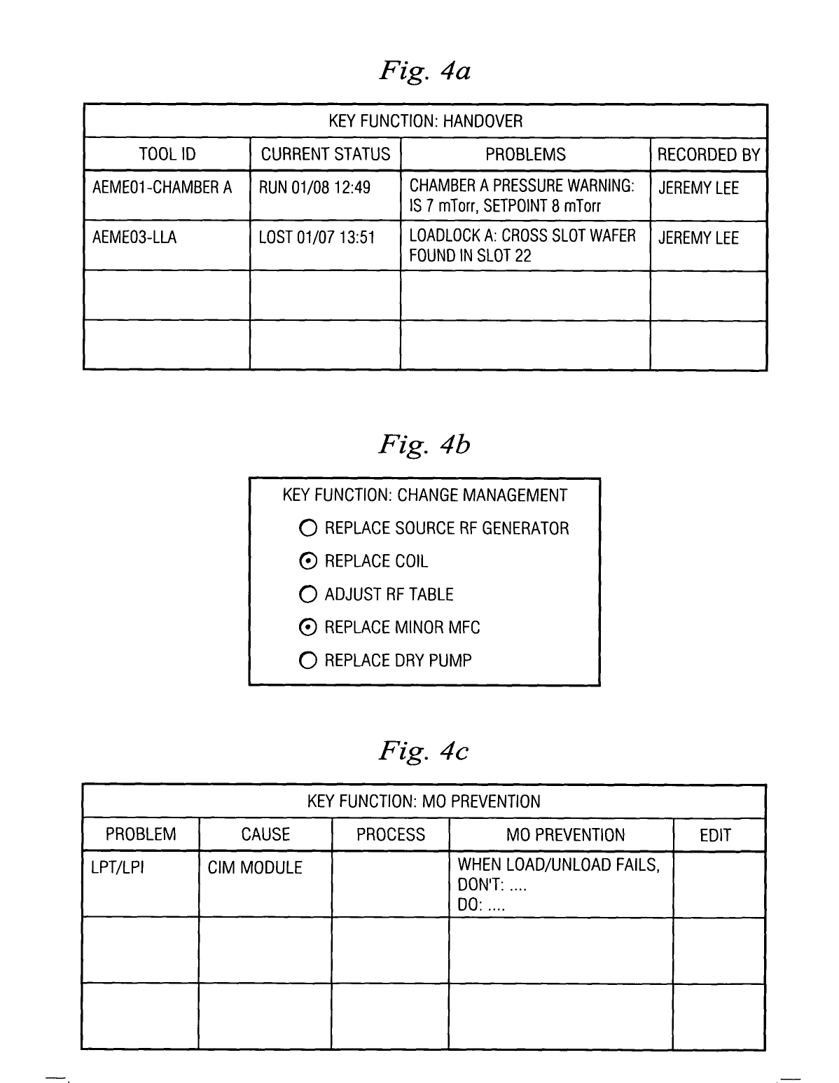

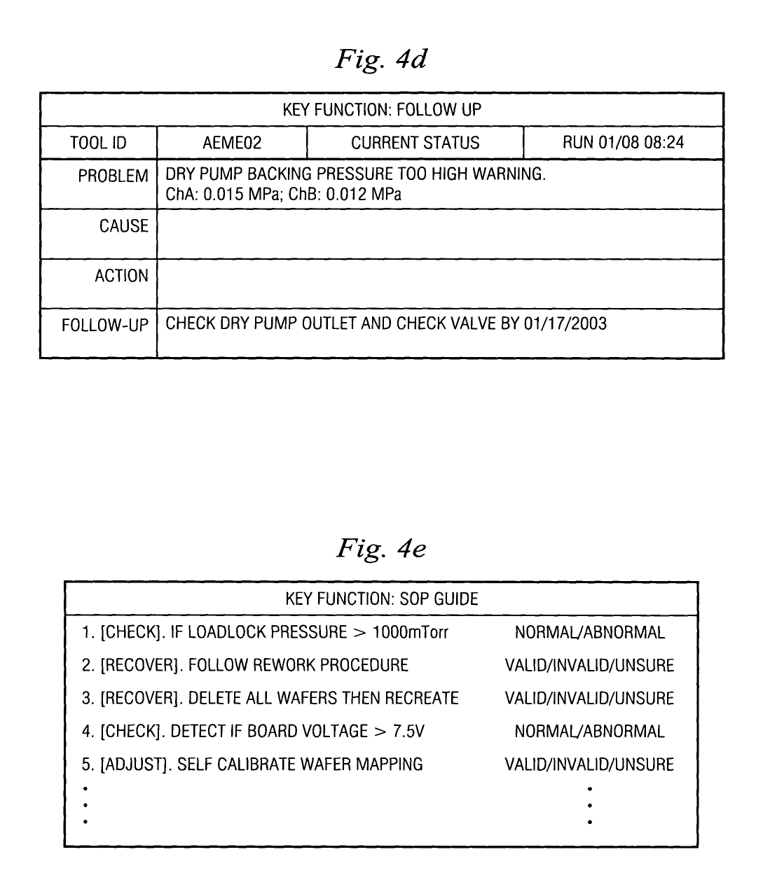

FIGS. 4a through 4e illustrate five user interfaces provided in a graphical user interface (GUI). The interfaces are provided by the KME function block (FIG. 1b) to one or more of the terminals 7, 8 (FIG. 1a). These interfaces are only a simplified examples and those of ordinary skill in the art will understand many different examples and many different types of information to be displayed.

FIG. 4a is an interface for electronic handover. The system will list all problems in details for handover from shift to shift.

FIG. 4b is an interface for change management. The users can use this interface to update the system for any tool changes, such as replacement, or adjustment for any maintenance actions. The system 5 will record and trace all tool changes.

FIG. 4c is an interface for MO prevention. Through this interface, users can directly add, delete or modify items in the MO table. Users can also record requirements events for any maintenance action through this interface.

FIG. 4d is an interface for follow-up. All open cases of tool problem can be followed and updated here.

FIG. 4e is an interface for the SOP guide. In this interface, the system 5 shows the SOP guide for the current maintenance action. A user can follow the SOP guide to work on maintenance step-by-step. Each SOP may also be a tree structure. Since each step in a SOP may contain a next level SOP which contains several sub-steps. Each sub-step may contain further sub-steps. The levels of sub-steps could be as many as necessary.

The present embodiments provide many different benefits. Both tool up time and production yield are improved significantly. The system helps engineers to avoid mistakes and improve maintenance quality. The system provides managers an overall view of operation status as well as details of engineers' work. Managers can also better discover additional alarm message, poor operation discipline, and engineer capability.

The present invention has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A virtual assistant system for facilitating semiconductor tool maintenance, the virtual assistant system comprising:
a first interface for receiving a tool alarm from a specified semiconductor tool;
a database including a first table for providing information as to what can and cannot be done to the specified semiconductor tool;
a first processing subsystem including instructions for deducting tool alarm information from the tool alarm; and
a second processing subsystem including instructions for receiving the tool alarm information, perusing the database, and identifying one or more causes associated with the tool alarm information.

2. The virtual assistant system of claim 1 wherein the database further includes a second table for providing routine maintenance information for the specified semiconductor tool.

3. The virtual assistant system of claim 2 wherein the database further includes a third table for providing a predetermined operating procedure for maintaining the specified semiconductor tool.

4. The virtual assistant system of claim 3 wherein the database further includes a fourth table for providing a list of high risk actions for the specified semiconductor tool.

5. The virtual assistant system of claim 1 wherein the second processing subsystem also includes instructions for identifying one or more actions to be performed on the specified semiconductor tool.

6. The virtual assistant system of claim 5 wherein:
the database further includes a second table for providing routine maintenance information for the specified semiconductor tool and a third table for providing a predetermined operating procedure for maintaining the specified semiconductor tool; and
the second processing subsystem also includes instructions for identifying maintenance actions to be performed on the specified semiconductor tool.

7. The virtual assistant system of claim 5 further comprising:
a second interface for sending the identified cause and action information to a mobile terminal.

8. The virtual assistant system of claim 1 further comprising:
a second interface for receiving input from external entities, the input including pre-collected knowledge about the semiconductor tool; and
wherein the first processor subsystem also includes instructions for updating the database from the received input.

9. A method for providing information to repair a semiconductor tool, the method comprising:
receiving a tool alarm when a tool problem occurs;
upon receipt of the tool alarm, providing tool alarm information to a database to determine a problem, cause, and action;
checking if the tool alarm information matches an item in a standard operation procedures (SOP) table of the database;
if the tool alarm information matches an item in the SOP table, providing SOP information to a tool alarm message;
sending the tool alarm message to a remote terminal for use in repairing the semiconductor tool.

10. The method of claim 9 further comprising:
checking if the tool alarm information matches an item in an allowances and restrictions table of the database;
if the tool alarm information matches an item in the allowances and restrictions table, providing allowances and restrictions information to the message.

11. The method of claim 9 further comprising:
checking if the tool alarm information matches an item in an requirements table of the database;
if the tool alarm information matches an item in the requirements table, providing requirements information to the message.

12. The method of claim 9 further comprising:
determining a problem, cause, and action associated with the tool alarm information by searching one or more problem trees, cause trees and action trees in the database;
providing problem, cause, and action information to the message.

13. The method of claim 9 further comprising:
updating the database with experiential knowledge provided from a plurality of different entities working on the semiconductor tool.

14. The method of claim 9 wherein the step of updating the database with experiential knowledge is performed on a daily basis.

15. The method of claim 9 further comprising:
updating the database with manufacture knowledge provided from one or more manufacture or repair facilities associated with the semiconductor tool.

16. The method of claim 9 wherein the step of updating the database with manufacture knowledge is performed on a repetitive basis.

17. An assistant system for use in maintaining a semiconductor tool, the assistant system comprising:
a first interface for receiving tool alarms from a plurality of different semiconductor tools connected via servos;
a database including a plurality of problem trees, a plurality of cause trees, and a plurality of action trees; and
a processing subsystem for analyzing the tool alarms by comparing them to the problem trees and providing a cause and action message based on the analysis.

18. The system of claim 17 wherein the problem trees include at least one group for software problems and another group for temperature-related problems.

19. The system of claim 18 wherein the group for software problems includes a subgroup for automatic control system problems.

20. The system of claim 18 wherein the group for temperature-related problems includes a subgroup for valve problems.

21. The system of claim 20 wherein the subgroup for temperature-related problems includes a further subgroup for user-defined problems.

22. The system of claim 20 wherein the subgroup for software problems includes a further subgroup for statistical process control problems.

23. The system of claim 21 wherein the subgroup for temperature-related problems is linked to at least one of the plurality of cause trees.

24. The system of claim 23 wherein the at least one of the plurality of cause trees includes a subgroup related to valve obstructions.

25. The system of claim 24 wherein the subgroup for valve obstructions is linked to at least one of the plurality of action trees.

26. The system of claim 25 wherein the at least one of the plurality of action trees includes a subgroup related to routine valve maintenance actions.

27. The system of claim 25 wherein the at least one of the plurality of action trees includes a subgroup related to recently added valve maintenance actions.

28. The system of claim 27 further comprising:
a second interface for receiving a plurality of valve maintenance actions from a maintenance entity that previously worked on the semiconductor tool, including the recently added valve maintenance actions.
